(19) United States
(12) Patent Application Publication
(10) Pub. No.: US 2007/0252089 A1
(43) Pub. Date: Nov. 1, 2007

(54) Charged particle acceleration apparatus and method

(75) Inventors: Jonathan Gorrell, Gainesville, FL (US); Mark Davidson, Florahome, FL (US); Michael E. Maines, Gainesville, FL (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Virgin Islands Microsystems, Inc., St. Thomas, VI (US)

(21) Appl. No.: 11/411,130

(22) Filed: Apr. 26, 2006

(51) Int. Cl. G01K 1/08

(52) U.S. Cl. 250/399; 315/500

(57) ABSTRACT

A charged particle beam including charged particles (e.g., electrons) is generated from a charged particle source (e.g., a cathode or scanning electron beam). As the beam is projected, it passes between plural alternating electric fields. In one embodiment, the electric fields alternate not only on the same side but across from each other as well. The attraction of the charged particles to their oppositely charged fields accelerates the charged particles, thereby increasing their velocities in the corresponding (positive or negative) direction. The velocity oscillation direction can be either perpendicular to the direction of motion of the beam or parallel to the direction of motion of the beam.

### CROSS-REFERENCE TO CO-PENDING APPLICATIONS

The present invention is related to the following co-pending U.S. patent applications: (1) U.S. patent application Ser. No. 11/238,991, [atty. docket 2549-0003], entitled “Ultra-Small Resonating Charged Particle Beam Modulator,” and filed Sep. 30, 2005, (2) U.S. patent application Ser. No. 10/917,511, filed on Aug. 13, 2004, entitled “Patterning Thin Metal Film by Dry Reactive Ion Etching,” and to U.S. application Ser. No. 11/203,407, filed on Aug. 15, 2005, entitled “Method Of Patterning Ultra-Small Structures,” (3) U.S. application Ser. No. 11/243,476 [Atty. Docket 2549-0058], entitled “Structures And Methods For Coupling Energy From An Electromagnetic Wave,” filed on Oct. 5, 2005, (4) U.S. application Ser. No. 11/243,477 [Atty. Docket 2549-0059], entitled “Electron Beam Induced Resonance,” filed on Oct. 5, 2005, and (5) U.S. application Ser. No. ______ [Atty. Docket 2549-0005], entitled “Micro Free Electron Laser (FEL),” filed on even date herewith, all of which are commonly owned with the present application at the time of filing, and the entire contents of each of which are incorporated herein by reference.

### BACKGROUND OF THE INVENTION

1. Field of the Invention

The present invention is directed to structures and methods of (positively or negatively) accelerating charged particles, and in one embodiment to structures and methods of accelerating electrons in an electron beam using a resonant structure which resonates at a frequency higher than a microwave frequency such that the structures and methods emit light.

2. Discussion of the Background

It is possible to emit a beam of charged particles according to a number of known techniques. Electron beams are currently being used in semiconductor lithography operations, such as in U.S. Pat. No. 6,936,981. The abstract of that patent also discloses the use of a “beam retarding system [that] generates a retarding electric potential about the electron beams to decrease the kinetic energy of the electron beams substantially near a substrate.”

An alternate charged particle source includes an ion beam. One such ion beam is a focused ion beam (FIB) as disclosed in U.S. Pat. No. 6,900,447 which discloses a method and system for milling. That patent discloses that “The positively biased final lens focuses both the high energy ion beam and the relatively low energy electron beam by functioning as an acceleration lens for the electrons and as a deceleration lens for the ions.” Col. 7, lines 23-27.

### SUMMARY OF THE INVENTION

It is an object of the present invention to provide a series of alternating electric fields to accelerate or decelerate charged particles being emitted from a charged particle source.

According to one embodiment of the present invention, a series of alternating electric fields provides transverse acceleration of charged particles (e.g., electrons) passing through the electric fields.

According to another embodiment of the present invention, a series of alternating electric fields provides axial acceleration and deceleration of charged particles passing through the fields.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a top-view, high-level conceptual representation of a charged particle moving through a series of alternating electric fields according to a first embodiment of the present invention;

FIG. 2 is a top-view, high-level conceptual representation of a charged particle accelerating while being influenced by at least one field of a series of alternating electric fields according to a second embodiment of the present invention;

FIG. 3 is a top-view, high-level conceptual representation of a charged particle decelerating while being influenced by at least one field of a series of alternating electric fields according to a second embodiment of the present invention;

FIG. 4 is a perspective-view, high-level conceptual representation of a charged particle moving through a series of alternating electric fields produced by a resonant structure;

FIGS. 5A-5C are the outputs of a computer simulation showing trajectories and accelerations of model devices using fields of +/−100V, +/−200V and +/−300V, respectively; and

FIG. 6 is a top-view, high-level conceptual representation of a charged particle moving through a series of alternating electric fields according to the embodiment of FIG. 1 but with the addition of a focusing element.

### DISCUSSION OF THE PREFERRED EMBODIMENTS

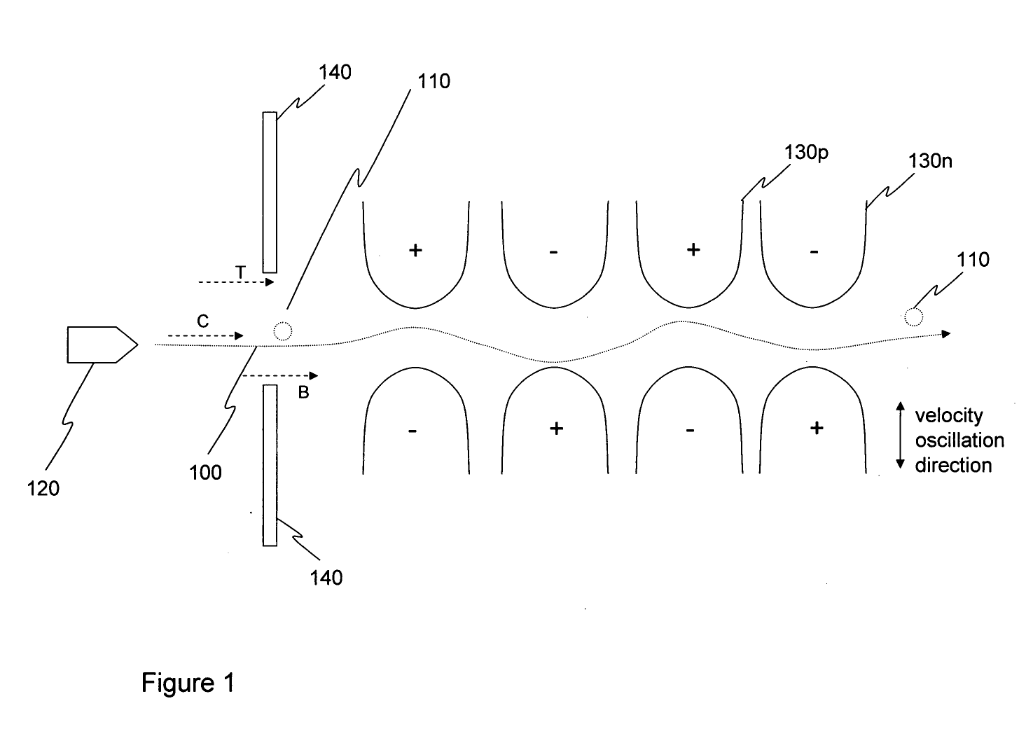

Turning now to the drawings, FIG. 1 is a high-level conceptual representation of a charged particle moving through a series of alternating electric fields according to a first embodiment of the present invention. As shown therein, a charged particle beam 100 including charged particles 110 (e.g., electrons) is generated from a charged particle source 120. (The charged particle beam 100 can include ions (positive or negative), electrons, protons and the like. The beam may be produced by any source, including, e.g., without limitation an ion gun, a thermionic filament, a tungsten filament, a cathode, a planar vacuum triode, an electron-impact ionizer, a laser ionizer, a chemical ionizer, a thermal ionizer, an ion-impact ionizer)

As the beam 100 is projected, it passes between plural alternating electric fields 130p and 130n. The fields 130p represent positive electric fields on the upper portion of the figure, and the fields 130n represent negative electric fields on the upper portion of the figure. In this first embodiment, the electric fields 130p and 130n alternate not only on the same side but across from each other as well. That is, each positive electric field 130p is surrounded by a negative electric field 130n on three sides. Likewise, each negative electric field 130n is surrounded by a positive field 130p on three sides. In the illustrated embodiment, the charged particles 110 are electrons which are attracted to the positive electric fields 130p and repelled by the negative electric fields 130n. The attraction of the charged particles 110 to their oppositely charged fields 130p or 130n accelerates the charged particles 110 transversely to their axial velocity.

The series of alternating fields creates an oscillating path in the directions of top to bottom of FIG. 1 and as indicated by the legend “velocity oscillation direction.” In such a case, the velocity oscillation direction is generally perpendicular to the direction of motion of the beam 100.

The charged particle source 120 may also optionally include one or more electrically biased electrodes 140 (e.g., (a) grounding electrodes or (b) positively biased electrodes) which help to keep the charged particles (e.g., (a) electrons or negatively charged ions or (b) positively charged ions) on the desired path.

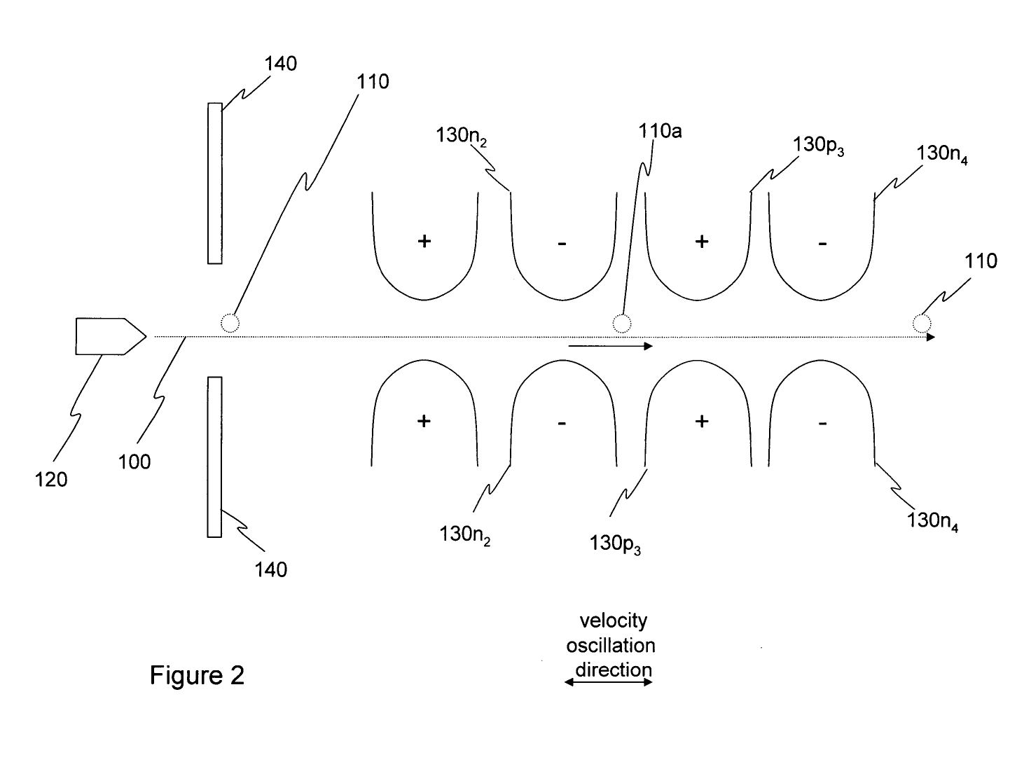

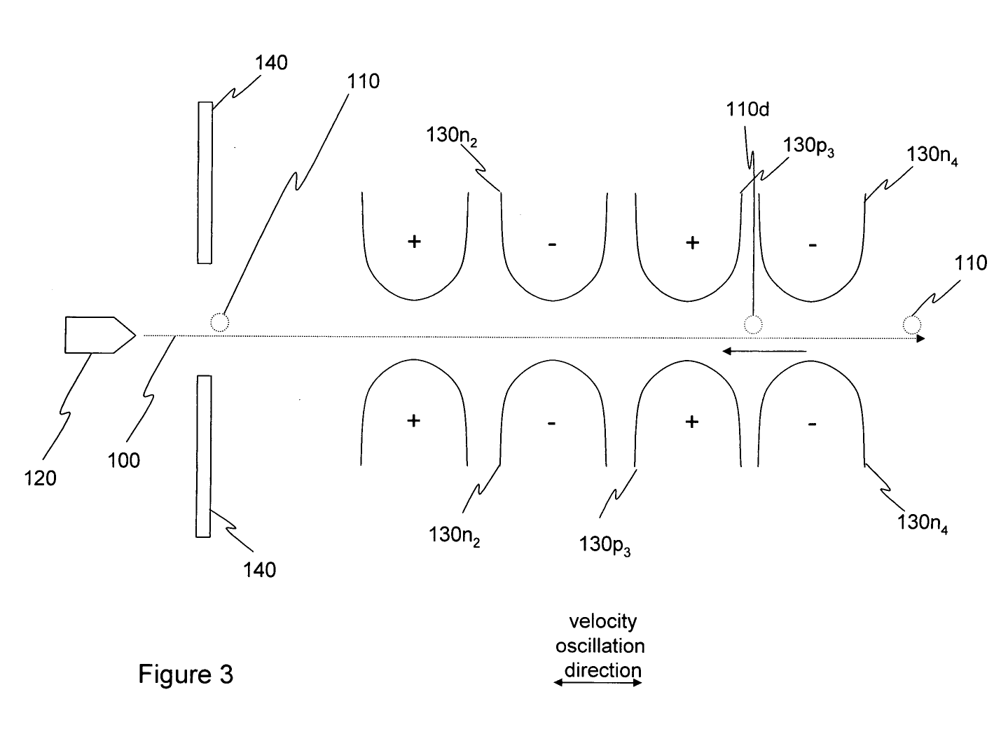

In the alternate embodiments illustrated in FIGS. 2 and 3, various elements from FIG. 1 have been repeated, and their reference numerals are repeated in FIGS. 2 and 3. However, the order of the electric fields 130p and 130n below the path of the charged particle beam 100 has been changed. In FIGS. 2 and 3, while the electric fields 130n and 130p are still alternating on the same side, they are now the same polarity on opposite sides of the beam 100. Thus, in the case of an electron acting as a charged particle 100, the electron 100a in FIG. 2 is an accelerating electron that is being accelerated by being repelled from the negative fields 130n₂ while being attracted to the next positive fields 130p₃ in the direction of motion of the beam 100. (The direction of acceleration is shown below the accelerating electron 100a.)

Conversely, as shown in FIG. 3, in the case of an electron acting as a charged particle 100, the electron 100d in FIG. 2 is a decelerating electron that is being decelerated (i.e., negatively accelerated) as it approaches the negative fields 130n₄ while still being attracted to the previous positive fields 130p₃. The direction of acceleration is shown below the decelerating electron 100d. Moreover, both FIGS. 2 and 3 include the legend “velocity oscillation direction” showing the direction of the velocity changes. In such cases, the velocity oscillation direction is generally parallel to the direction of motion of the beam 100.

By varying the order and strength of the electric fields 130n and 130p, a variety of accelerations, and therefore motions, can be created. As should be understood from the disclosure, the strengths of adjacent electric fields, fields on the same side of the beam 100 and fields on opposite sides of the beam 100 need not be the same strength. Moreover, the strengths of the fields and the polarities of the fields need not be fixed either but may instead vary with time. The fields 130n and 130p may even be created by applying a electromagnetic wave to a resonant structure, described in greater detail below.

The electric fields utilized by the present invention can be created by any known method which allows sufficiently fine-grained control over the paths of the charged particles that they stay within intended path boundaries.

According to one aspect of the present invention, the electric fields can be generated using at least one resonant structure where the resonant structure resonates at a frequency above a microwave frequency. Resonant structures include resonant structures shown in or constructed by the teachings of the above-identified co-pending applications. In particular, the structures and methods of U.S. application Ser. No. 11/243,477 [Atty. Docket 2549-0059], entitled “Electron Beam Induced Resonance,” filed on Oct. 5, 2005, can be utilized to create electric fields 130 for use in the present invention.

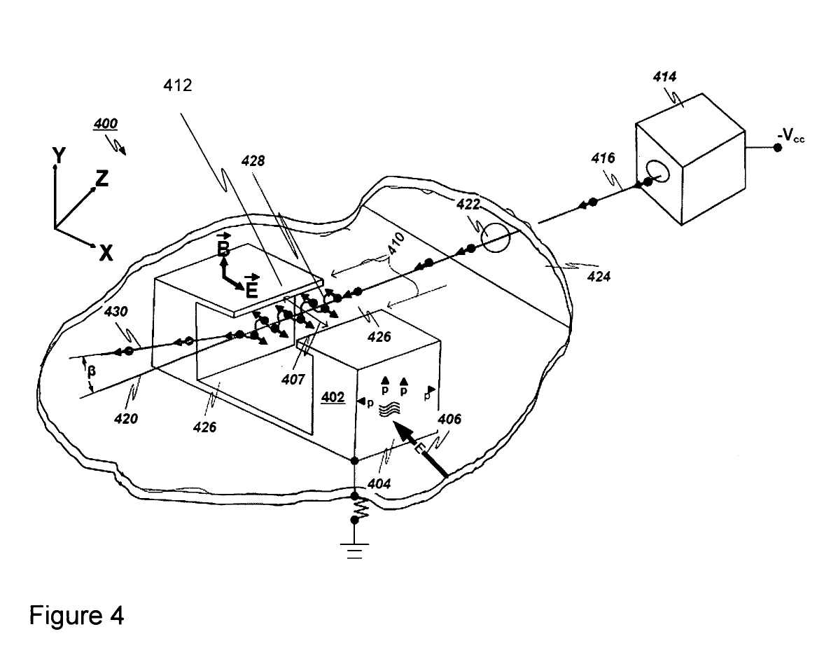

FIG. 4 is a perspective-view, high-level conceptual representation of a charged particle moving through a series of alternating electric fields produced by a microwave resonant structure (RS) 402 (e.g., a microwave resonant structure or an optical resonant structure). An electromagnetic wave 406 (also denoted E) incident to a surface 404 of the RS 402 transfers energy to the RS 402, which generates a varying field 407. In the exemplary embodiment shown in FIG. 4, a gap 410 formed by ledge portions 412 can act as an intensifier. The varying field 407 is shown across the gap 410 with the electric and magnetic field components (denoted E̅ and B̅) generally along the X and Y axes of the coordinate system, respectively. Since a portion of the varying field can be intensified across the gap 410, the ledge portions 412 can be sized during fabrication to provide a particular magnitude or wavelength of the varying field 407.

A charged particle source 414 (such as the source 120 described with reference to FIGS. 1-3) targets a beam 416 (such as a beam 100) of charged particles (e.g., electrons) along a straight path 420 through an opening 422 on a sidewall 424 of the device 400. The charged particles travel through a space 426 within the gap 410. On interacting with the varying field 426, the charged particles are shown angularly modulated from the straight path 420. Generally, the charged particles travel on an oscillating path 428 within the gap 410. After passing through the gap 410, the charged particles are angularly modulated on a new path 430. An angle β illustrates the deviation between the new path 430 and the straight path 420.

As would be appreciated by one of ordinary skill in the art, a number of resonant structures 402 can be repeated to provide additional electric fields for influencing the charged particles of the beam 416. Alternatively, the direction of the oscillation can be changed by turning the resonant structure 402 on its side onto surface 404.

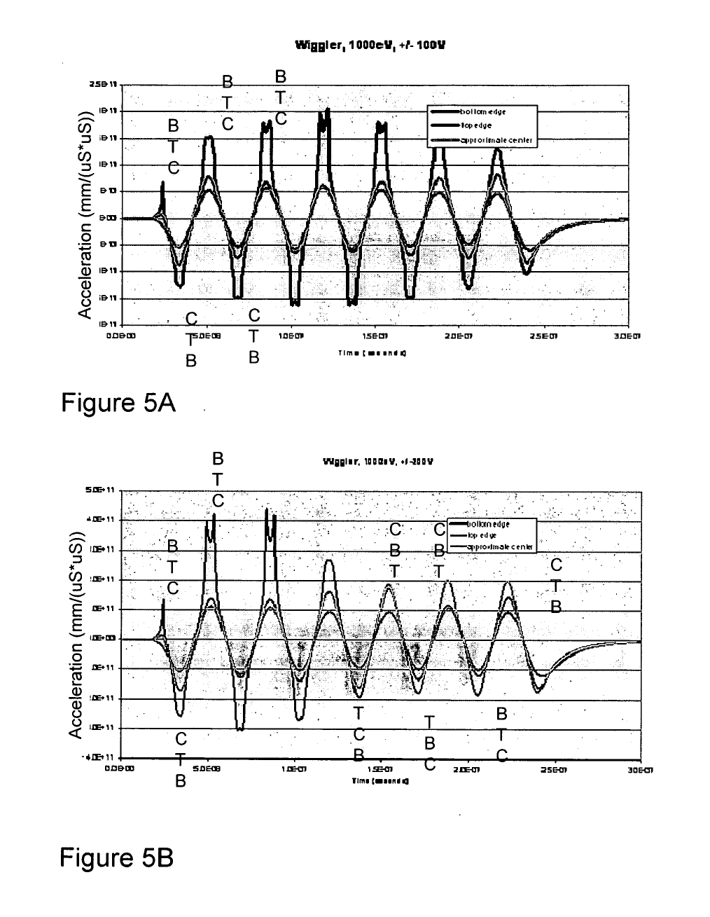

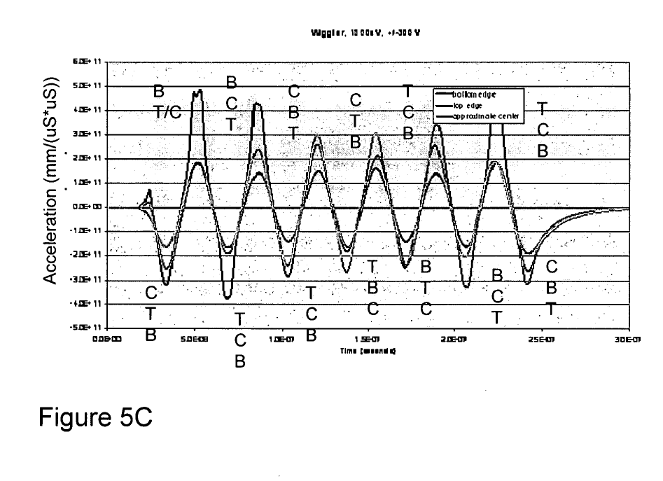

FIGS. 5A-5C are outputs of computer simulations showing trajectories and accelerations of model devices according to the present invention. The outputs illustrate three exemplary paths, labeled “B”, “T” and “C” for bottom, top and center, respectively. As shown on FIG. 1, these correspond to charged particles passing through the bottom, top and center, respectively, of the opening between the electrodes 140. Since the curves for B, T and C cross in various locations, the graphs are labeled in various locations. As can be seen in FIG. 5A, the calculations show accelerations of about 0.5×10¹¹ mm/μS² for electrons with 1 keV of energy passing through a field of +/−100 volts when passing through the center of the electrodes. FIG. 5B shows accelerations of about 1.0×10¹¹ mm/μS² for electrons with 1 keV of energy passing through a field of +/−200 volts when passing through the center of the electrodes. FIG. 5C shows accelerations of about 1.0-3.0×10¹¹ mm/μS² for electrons with 1 keV of energy passing through a field of +/−300 volts when passing through the center of the electrodes.

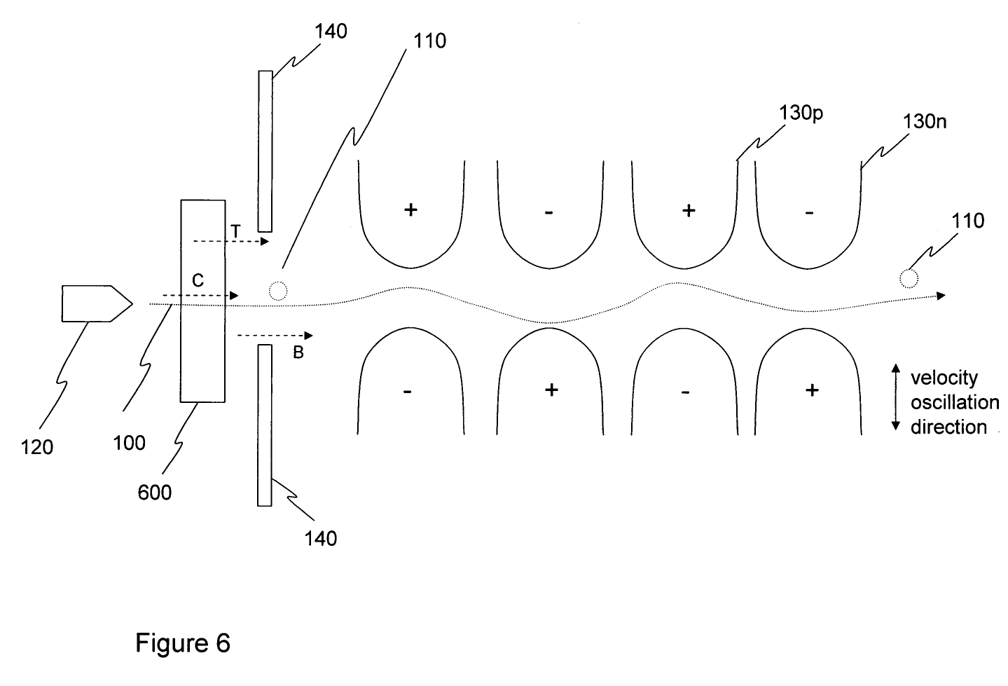

In light of the variation in paths that a charged particle can undergo based on its initial path between electrodes 140, a focusing element 600 may be added in close proximity to the electrodes 140, as shown in FIG. 6. The focusing element 600, while illustrated before the electrodes 140 may instead be placed after. In such a configuration, additional charged particles may traverse a center path between the fields. Additionally, the focusing element, while shown in a FIG. 1-style configuration, can also be used in other configurations, such as is shown in FIGS. 2-4.

It is also possible to construct the electrode of such a size and spacing that they resonate at or near the frequency that is being generated. This effect can be used to enhance the applied fields in the frequency range that the device emits.

Utilizing the alternating electric fields of the present invention, the oscillating charged particles emit photons to achieve a radiation emitting device. Such photons can be used to provide radiation to an outside of the device or to produce radiation for use internal to the device as well. Moreover, the amount of radiation produced can be used as part of measurement devices.

While the above-description has been made in terms of structures for achieving the acceleration of charged particles, the present invention also encompasses methods of accelerating charged particles generally. Such a method includes: generating a beam of charged particles; providing a series of alternating electric fields along an intended path; and transmitting the beam of charged particles along the intended path through the alternating electric fields.

The charged particle accelerating structures described above can be laid out in rows, columns, arrays or other configurations such that the intensity of the resulting EMR is increased.

The emitted EMR produced may additionally be used as an input to additional devices. For example, the EMR may be used as an input to a light amplifier or may be used as part of transmission system.

As would be understood by one of ordinary skill in the art, the above exemplary embodiments are meant as examples only and not as limiting disclosures. Accordingly, there may be alternate embodiments other than those described above which nonetheless still fall within the scope of the pending claims.

1. A charged particle accelerating structure comprising:
a series of alternating electric fields along an intended path; and
a source of charged particles configured to transmit charged particles along the intended path through the alternating electric fields such that the charged particles undergo a series of alternating accelerations.

2. The structure as claimed in claim 1, wherein the series of alternating accelerations are in a direction substantially perpendicular to the intended path.

3. The structure as claimed in claim 1, wherein the series of alternating accelerations are in a direction substantially parallel to the intended path.

4. The structure as claimed in claim 1, wherein the charged particles comprise electrons.

5. The structure as claimed in claim 1, wherein the charged particles comprise positively charged ions.

6. The structure as claimed in claim 1, wherein the charged particles comprise negatively charged ions.

7. The structure as claimed in claim 1, wherein the series of alternating electric fields comprises alternating adjacent electric fields and fields of opposite polarity on opposite sides of the intended path.

8. The structure as claimed in claim 1, wherein the series of alternating electric fields comprises alternating adjacent electric fields and fields of the same polarity on opposite sides of the intended path.

9. The structure as claimed in claim 1, wherein at least one of the alternating electric fields is created using a resonant structure configured to resonate at a frequency higher than a microwave frequency.

10. The structure as claimed in claim 1, further comprising a focusing element.

11. A method of accelerating charged particles, comprising:
generating a beam of charged particles;
providing a series of alternating electric fields along an intended path; and
transmitting the beam of charged particles along the intended path through the alternating electric fields such that the charged particles undergo a series of alternating accelerations.

12. The method as claimed in claim 11, wherein the series of alternating accelerations are in a direction substantially perpendicular to the intended path.

13. The method as claimed in claim 11, wherein the series of alternating accelerations are in a direction substantially parallel to the intended path.

14. The method as claimed in claim 11, wherein the charged particles comprise electrons.

15. The method as claimed in claim 11, wherein the charged particles comprise positively charged ions.

16. The method as claimed in claim 11, wherein the charged particles comprise negatively charged ions.

17. The method as claimed in claim 11, wherein the series of alternating electric fields comprises alternating adjacent electric fields and fields of opposite polarity on opposite sides of the intended path.

18. The method as claimed in claim 11, wherein the series of alternating electric fields comprises alternating adjacent electric fields and fields of the same polarity on opposite sides of the intended path.

19. The method as claimed in claim 11, wherein at least one of the alternating electric fields is created using a resonant structure configured to resonate at a frequency higher than a microwave frequency.

20. The method as claimed in claim 11, further comprising focusing the charged particles prior to substantially a center of the alternating electric fields prior to transmitting the beam of charged particles into the alternating electric fields.
